(19) United States
(12) Patent Application Publication
(10) Pub. No.: US 2026/0138006 A1
(43) Pub. Date: May 21, 2026

(54) MULTI-MODE TURRET-STYLE GAME INPUT CONTROLLER

(71) Applicant: Helix Leisure Pte Ltd., Singapore (SG)

(72) Inventors: Ian Kwan, Singapore (SG); Timothy Syn Yong Zhong, Singapore (SG); Steven Joseph Bibeau, Singapore (SG)

(21) Appl. No.: 19/371,082

(22) Filed: Oct. 28, 2025

Related U.S. Application Data
(60) Provisional application No. 63/722,972, filed on Nov. 20, 2024.

(51) Int. Cl. A63F 13/245; A63F 13/211

(52) U.S. Cl. CPC A63F 13/245; A63F 13/211

(57) ABSTRACT

An input controller for a player of game includes a user engaging portion mounted to a mounting portion for selective rotation about a first axis and the mounting portion mounted to a base portion for selective rotation about a second axis, thus permitting the user engaging portion mounted to the mounting portion to rotate about the second axis, and the base portion mounted for selective rotation about a third axis, thus permitting the user engaging portion to rotate about the third axis. In a first operational mode movement of the user engaging portion about the first axis is prevented but the user engaging portion may rotate about the second axis and the third axis, and in a second operational mode movement of the user engaging portion about the second axis and the third axis is prevented but the user engaging portion may rotate about the first axis.

### RELATED APPLICATION DATA

The present application claims priority to U.S. Provisional Application Ser. No. 63/722,972, filed Nov. 20, 2024, which prior application is incorporated by reference in its entirety herein.

### FIELD OF THE INVENTION

The present invention relates to user input devices, and particularly those used by players of games.

### BACKGROUND OF THE INVENTION

A wide variety of input devices have been developed to enable players to provide inputs to play games. For example, these input devices may be as simple as push-buttons on the sides of pinball machines for actuating the ball flippers, or be hand-held controllers with joysticks and/or buttons, such as for providing inputs to a video game.

In order to enhance the game play experience, game input devices may be configured to emulate real-world input devices. For example, in the realm of arcade gaming, physical simulations of equipment such as turrets and steering mechanisms (steering wheels) have long been used to enrich player interaction and provide a tactile dimension to the gaming experience. However, these installations typically exist in separate arcade setups, with each specialized for a specific type of simulation. For example, a “tank” arcade game may include a specialized turret controller and a racing arcade game may include a specialized steering mechanism.

In addition, traditionally, arcade turrets offer a static experience with limited feedback, focusing mainly on the visual and audio aspects of the game. While this can provide a level of engagement, the absence of physical actuation and nuanced haptic feedback diminishes the sense of immersion and realism. Similarly, arcade driving simulators may incorporate haptic feedback to simulate road conditions and vehicle dynamics, but often lack the sophisticated control and interaction mechanisms found in combat simulations. This segregation of experiences represents a missed opportunity for creating a unified, immersive gaming platform that offers a comprehensive array of physical feedback and control fidelity across different simulation genres.

The evolution of game technology, including both gaming environments which offer players the opportunity to play multiple different games or provide inputs of different types as well as virtual reality (VR) technology which provides a much more immersive and engaging gaming experiences, pushes the boundaries of traditional input devices. The present invention is directed towards solving these and other problems.

### SUMMARY OF THE INVENTION

Aspects of the invention comprise an input controller for a game or event, and preferably a video based event, such as a video game, and most preferably a VR game. Additional aspects of the invention comprise a method of operating or controlling an input controller, and a game or gaming system having an input controller.

In one embodiment, an input controller for a player of a video-based event comprises a user engaging portion, a base portion and a mounting portion, the user engaging portion mounted to the mounting portion for selective rotation about a first axis and the mounting portion mounted to the base portion for selective rotation about a second axis, thus permitting the user engaging portion mounted to the mounting portion to rotate about the second axis, and the base portion mounted for selective rotation about a third axis, thus permitting the user engaging portion to rotate about the third axis. The input controller further comprises a means for restricting movement of the user engaging portion about the first axis, the base portion about the second axis and the mounting portion about the third axis, a processor, a memory embodying non-transitory machine-readable code, the machine-readable code when executed by the processor configured to cause the processor to: implement a first operational controller mode which causes the means for restricting to prevent movement of the user engaging portion about the first axis but permits the user engaging portion to rotate about the second axis and the third axis; and implement a second operational controller mode which causes the means for restricting to prevent movement of the user engaging portion about the second axis and the third axis and permits the user engaging portion to rotate about the first axis.

Further objects, features, and advantages of the present invention over the prior art will become apparent from the detailed description of the drawings which follows, when considered with the attached figures.

### DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective front view of a multi-mode game input controller in accordance with an embodiment of the invention;

FIG. 2 is a perspective rear bottom view of the game input controller in accordance with FIG. 1;

FIG. 3 is a first exploded view of the game input controller in accordance with FIG. 1, showing primary portions thereof;

FIG. 4 is a second exploded view of the game input controller illustrated in FIG. 4, showing additional internal components thereof;

FIG. 5 is a cross-sectional side view of the game input controller illustrated in FIG. 1;

FIGS. 6 & 7 are front and rear perspective views of a main housing portion of the game input controller illustrated in FIG. 1 with a cover thereof removed; and

FIG. 8 is a schematic diagram of aspects of the multi-mode game input controller in accordance with FIG. 1.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Aspects of the invention comprise an input controller for a game or event, such as a video based event, such as a video game, and most preferably a VR game. Additional aspects of the invention comprise a method of operating or controlling an input controller, and a game or gaming system having an input controller.

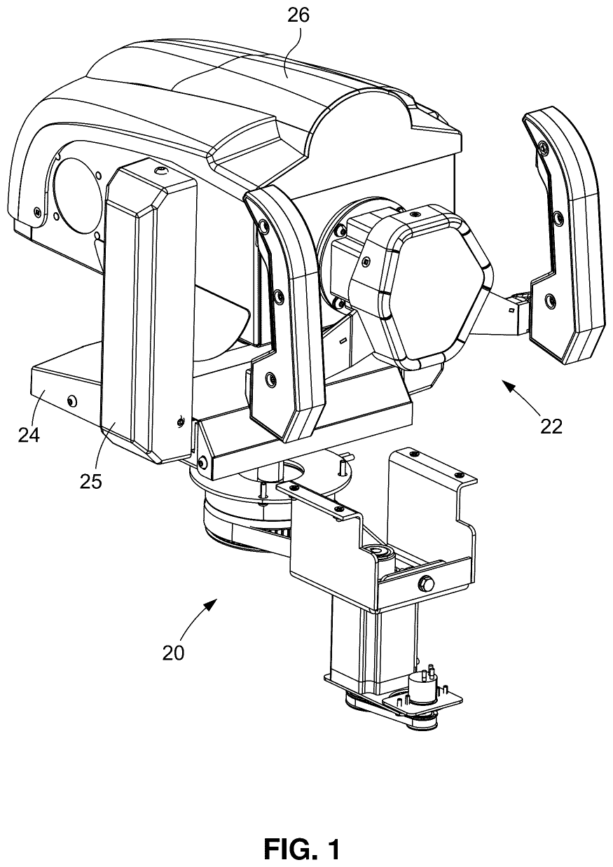

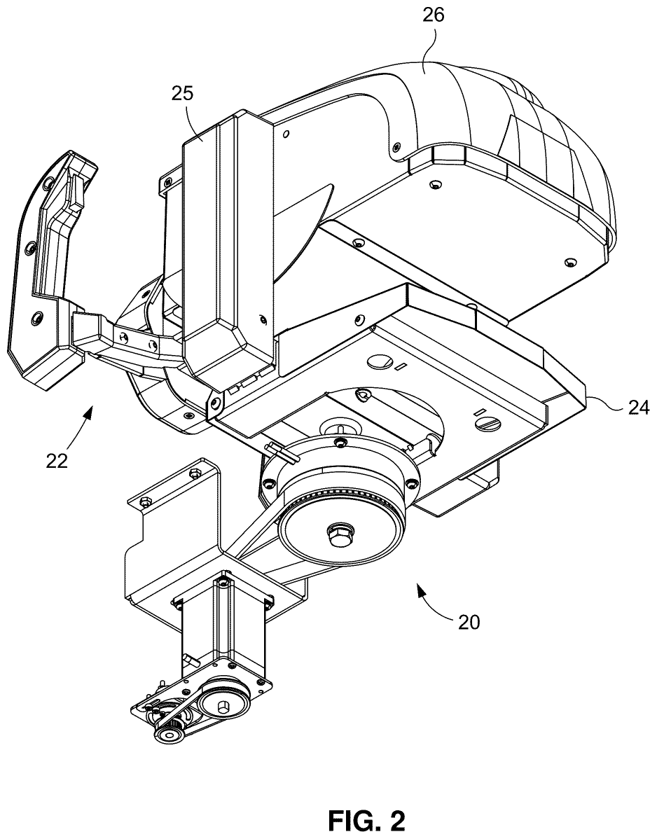

One aspect of the invention will be described with reference to FIGS. 1-7, which show a multi-mode game input controller 20. In one embodiment, the controller 20 is configured to operate in at least a first mode and a second mode. Preferably, one or more portions of the controller are movable in each of the modes. Most preferably, the controller is movable about different axes in each of the modes.

In one configuration, the controller 20 has a user engaging portion 22. The user engaging portion 22 may comprise or be configured as a steering wheel, yoke or have other shapes or configurations. Preferably, the user engaging portion 22 is configured to be gripping by the hands of a user to permit the user to move the user engaging portion 22. As described below, this may comprise rotating the user engaging portion 22, pushing or pulling the user engaging portion, or moving the user engaging portion in other manners.

In one embodiment, the user engaging portion 22 is movably connected to a base portion 24. The base portion 24 may have various shapes and sizes, and may define an interior area for housing one or more components of the controller. Preferably, as detailed below, the base portion 24 is itself movably mounted to a support structure, such as a housing of a gaming device (such as the housing or other structure of an amusement game, such as a VR game).

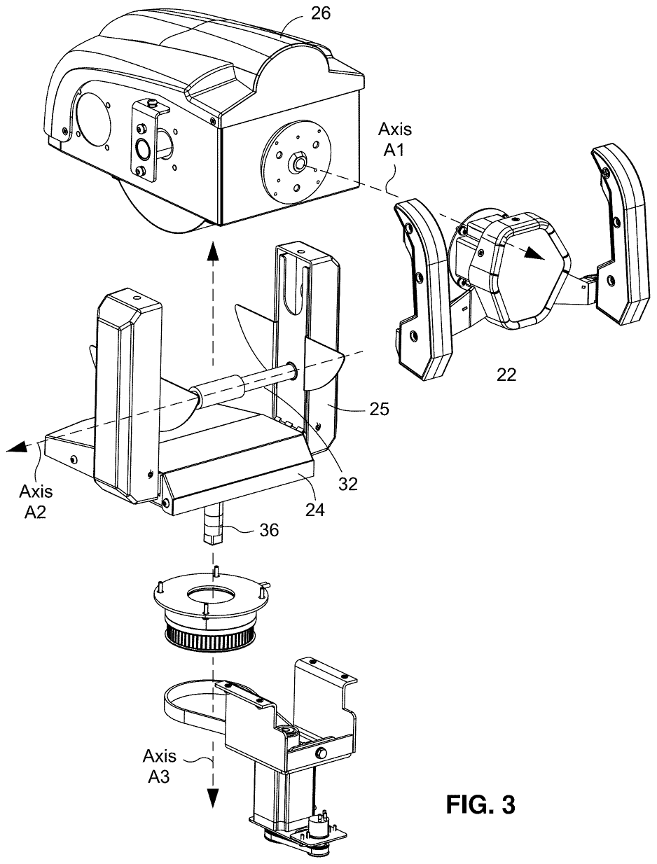

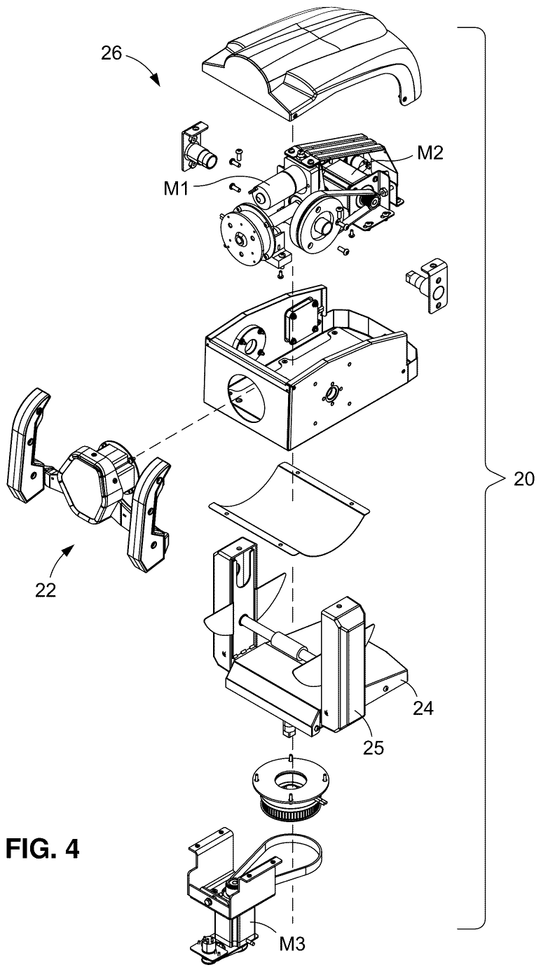

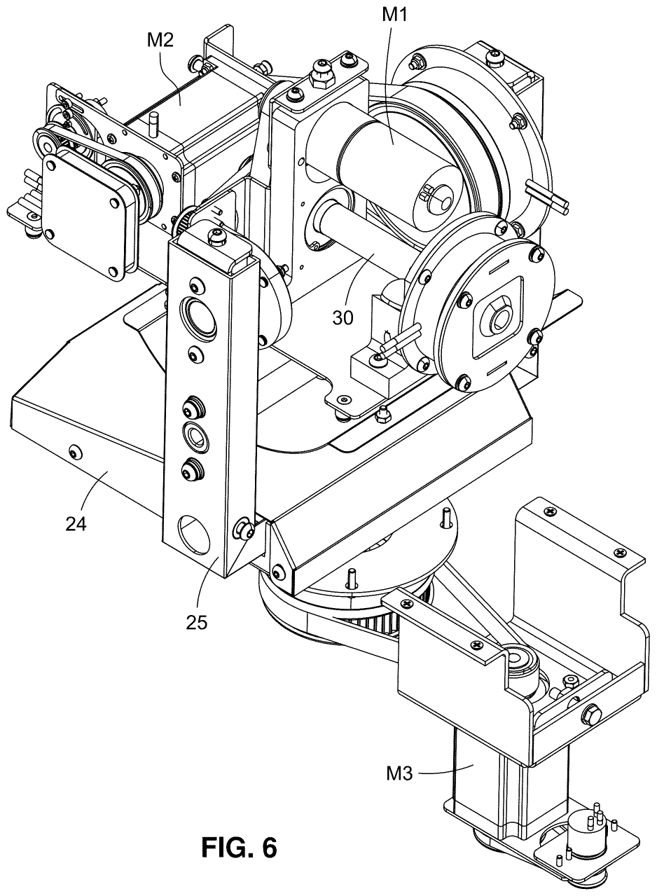

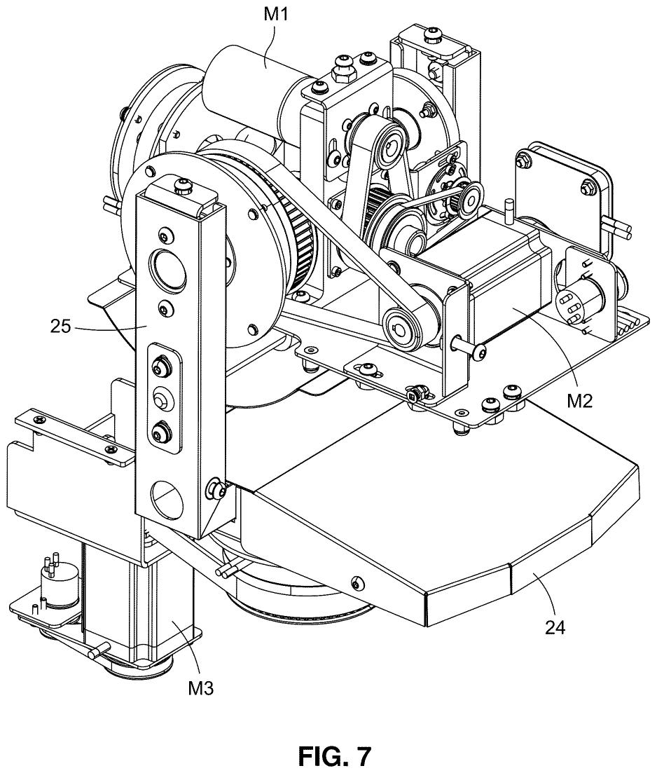

In one preferred configuration, the user engaging portion 22 is configured for selective rotation around a first axis A1. For example, the user engaging portion 22 may be mounted on a first shaft 30 (see FIG. 6) which is supported by a mounting portion 26, which mounting portion 26 is in turn connected to the base portion 24, such that the shaft is selectively movable with respect thereto (or the user engaging portion is rotatable relative to the shaft, such as by being mounted on a bearing on the shaft). In such a configuration, clock-wise and counter-clockwise rotational inputs by a user to the user engaging portion 22 may effectuate rotation thereof abut the first axis A1 (see FIG. 3). As illustrated, the mounting portion 26 may house a number of components of the controller 20, and may comprise a housing which includes a removable cover, such as to permit access to an otherwise closed interior portion thereof.

Preferably, the user engaging portion 22 is also configured for selective rotation about a second axis A2. In one embodiment, the second axis A2 is perpendicular to the first axis A1, and in a preferred embodiment, the second axis is generally horizontal. As illustrated, the mounting portion 26 may be configured for rotation via one or more second shafts 32 (see FIG. 3). As illustrated, an arm 25 may extend upwardly from the base portion 24 to both sides of the mounting portion 26, which arms each support a second shaft 32 that permits the mounting portion 26 to rotate relative to the arms 25 about axis A2. This allows the mounting portion 26, and thus the engaging portion 22, to be rotated about the second axis (with respect to the base portion 24). In such a configuration, a raising or lowering input to the user engaging portion 22 (e.g. a “tilting” input) may effectuate rotation of the user engaging portion 22 about the second axis A2.

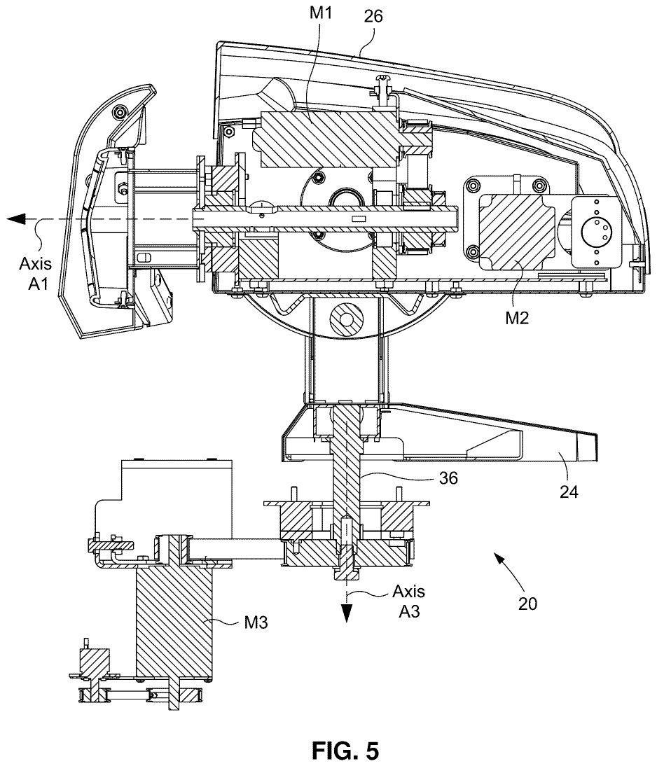

Preferably, the user engaging portion 22 is also selectively rotatable about a third axis A3. In one embodiment, the third axis A3 is perpendicular to the second axis A2, and in a preferred embodiment, the third axis is vertically extending. In one embodiment, the user engaging portion 22 may be rotatable about the third axis A3 by rotatable mounting of the base portion 24 to a support structure, such as the gaming device housing or a base plate which is connected to a gaming device housing. Once again, this mounting may be a rotatable shaft, such as a third shaft 36 (or a rotational mounting to such a shaft; see FIGS. 3 and 5)). In this configuration a lateral (left to right or right to left) input to the user engaging portion 22 may effectuate rotation of the user engaging portion about the third axis A3.

It will be appreciated that in some embodiments, a player provide more than one input, such as a tilting input (rotation around the second axis A2) and a pivoting input (rotation around the third axis A3), or other combinations of inputs, at the same time.

Importantly, the controller 20 preferably has a plurality of modes of operation, wherein in different modes of operation, movement of the controller 20 may be permitted or prevented.

For example, in one embodiment, the controller 20 may be configured in a first mode of operation. This mode of operation may be referred to as a “turret mode.” In this mode, rotation of the user engaging portion 22 about the first axis A1 may be locked or prevented, which movement or rotation of the user engaging portion 22 about the second axis A2 and third axis A3 may be permitted.

The controller 20 may also be configured in a second mode of operation. This mode of operation may be referred to as a “driving mode.” In this mode, rotation of the user engaging portion 22 about the first axis A1 may be permitted, but movement or rotation of the user engaging portion 22 about the second axis A2 and third axis A3 may be locked or prevented.

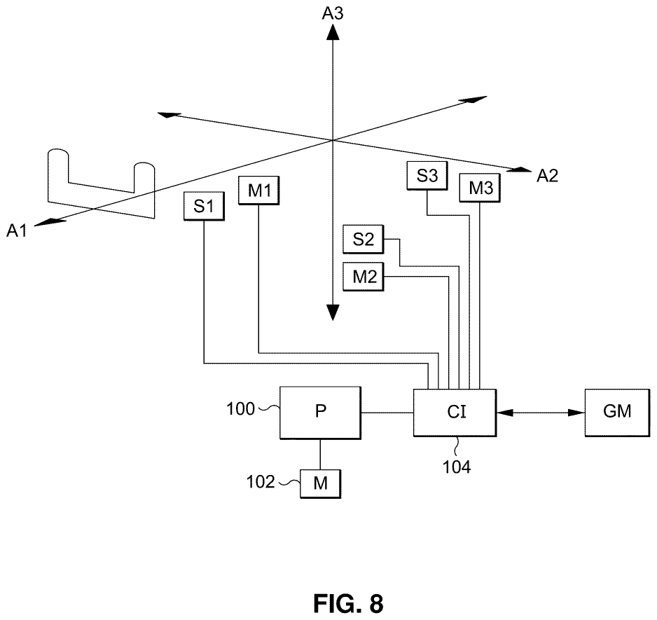

In one embodiment, as illustrated in FIG. 8, the controller 20 preferably includes a processor 100, a memory 102, machine-readable code stored in the memory and executable by the processor. The controller 20 may also include one or more communication interfaces 104, such as to permit information to be provided to the processor 100 or to be output therefrom. For example, the communication interface 104 might comprise a USB port or interface, an RS-232 interface, or others. The communication interface 104 preferably permits the processor 100 of the controller 20 to communicate with other devices, such as those described below and the gaming machine GM with which the controller 20 is associated (such as the processor thereof).

In one embodiment, the controller 20 includes a means for resisting movement of the user engaging portion 22. In one embodiment, this means is capable of limiting or preventing movement of the user engaging portion 22.

In one embodiment, the means comprises one or more sensors and one or more motors. As illustrated in FIG. 8, a first position sensor S1 is preferably configured to detect a position of the user engaging portion 22 relative to the first axis A1. For example, the first position sensor S1 may be a rotational position sensor which is associated with the first shaft. A second position sensor S2 is preferably configured to detect a position of the user engaging portion 22 relative to the second axis A2. For example, the second position sensor S2 may be a rotational position sensor which is associated with the second shaft. A third position sensor S3 is preferably configured to detect a position of the user engaging portion 22 relative to the third axis A3. For example, the third position sensor S3 may be a rotational position sensor which is associated with the third shaft.

In one embodiment, the means may further comprise one or more motors, which motors generate an output which is used to resist or control (prevent/limit) movement of the user engaging portion 22. As illustrated in FIGS. 4-6, a first motor M1 is preferably configured to resist or limit movement of the user engaging portion 22 relative to the first axis A1. For example, an output of the first motor M1 may be applied to the first shaft, such as via one or more gears, a pulley and belt drive or other drive configuration. A second first motor M2 is preferably configured to resist or limit movement of the user engaging portion 22 relative to the second axis A2. For example, an output of the second motor M2 may be applied to the second shaft, such as via one or more gears, a pulley and belt drive or other drive configuration. A third motor M3 is preferably configured to resist or limit movement of the user engaging portion 22 relative to the third axis A3. For example, an output of the third motor M3 may be applied to the third shaft, such as via one or more gears, a pulley and belt drive or other drive configuration.

In one embodiment, the processor 100 is configured to receive the outputs from the sensors S1, S2 and S3 (such as via the communication interface 104) and generate motor control instructions which are output to the motors M1, M2 and M3. The sensor output information may comprise position information or might comprise position information and rate of change of position information (or the processor 100 might calculate rate of change of position from a sequence of position information). For example, the output of the sensors S1, S2 and S3 represent input to the user engaging portion 22 by the user, and may be transmitted to a game processor or be processed by the processor 100 and be outputted to the game processor as game play inputs to a game being played (e.g. a player's input to the user engaging portion 22 which causes the mounting portion 26 to rotate clockwise (to the right) about the third axis A3 may be detected by the sensor S3, with the output of that sensor S3 being provided as an input to a game controller which causes the game controller to effectuate a graphical display of an equivalent movement of an on-screen object or background, etc., as is known in the art. As another aspect of the invention, rate of change or absolute detected rotational change may be used by the processor 100 to generate a variable resistance output.

In one embodiment, the processor 100 is configured, such as by execution of the machine-readable code stored in the memory 102, to implement the modes of operation as described above and to selectively resist movement of the user engaging portion 22. For example, relative to the first mode of operation, the processor 100 may be configured to control the first motor M1 so that it effectively prevents rotation of the user engaging portion 22 about the first axis A1 (such as by generating a resistive force in opposition to any user input to the user engaging portion 22 about the first axis A1). At the same time, the processor 100 may be configured to control the second motor M2 and the third motor M3 in a manner which permits movement or rotation of the user engaging portion 22 about the second axis A2 and third axis A3. Preferably, while the second motor M2 and third motor M3 are controlled to permit this rotation, they are controlled to resist the movement, as detailed below.

Similarly, relative to the second mode of operation, the processor 100 may be configured to control the first motor M1 to permit rotation of the user engaging portion 22 about the first axis A1, but control the second motor M2 and the third motor M3 to prevent rotation of the user engaging portion 22 about the second axis A2 and third axis A3.

In one embodiment, when the processor 100 is configured to permit rotation of the user engaging portion 22 (such as about a particular axis), the processor may be configured to permit the rotation as against a generated resistive force. In one embodiment, the processor 100 is configured to control the motors M1, M2 and M3 in relation to a default or neutral position. Preferably, when movement of the user engaging portion 22 is prevented or locked relative to an axis, the user engaging portion 22 is locked in the neutral position relative to that axis (such as a position midway between a maximum rotational position in either opposing direction; for example relative to a driving mode where the user engaging portion 22 can be rotated between a maximum left rotational and maximum right rotational position, the neutral position may be the “straight” position therebetween). When movement of the user engaging portion 22 is permitted, it may be resisted, such as in a manner which provides feedback to the user. The generated resistive force (generated by each motor, as applicable) may be linear or it may be non-linear, such as increasing as the user engaging portion 22 is moved away from the neutral position, or based upon the speed of rotation by the user. For example, in the second mode of operation where the user engaging portion 22 is permitted to rotate around the first axis A1, a small resistive force may be generated by the motor M1 against user movement of the user engaging portion 22 from the neutral position to a first, smaller rotational position. However, a larger resistive force may be applied as the user attempts to move the user engaging portion from the first rotational position to a larger rotational position. In other or additional configurations, the processor 100 may generate an output which causes a smaller resistive force to be generated by the motors when a rate of change in rotation is small, but to generate an output which causes a large resistive force to be generated when a rate of change in rotation is large (e.g. the force which is user must apply to effectuate a fast rotational input is higher than for a slow rotational input).

Of course, the controller 20 might be configured to operate in other modes than the first and second modes above. In some embodiments, the controller 20 may be configured to allow the user engaging portion 22 to be moved in other manners, such as linearly along one or more of the axes.

In one embodiment, the processor 100 of the controller 20 may receive instructions or commands from a controller of an associated gaming device, such as to cause the processor 100 to implement the first or second modes. For example, if a player of a gaming device selects a first game, the controller of the gaming device may send an instruction to the processor 100 of the controller 20 to cause it to implement the first mode, whereas if the player of the gaming device selects a second game, the controller of the gaming device may send an instruction to the processor 100 to implement the second mode. As another example, during the play of a particular game, the controller of the gaming device may send instructions to cause the processor 100 of the controller 20 to implement the first or second modes, such as at different times during the game.

As indicated above, the output of the sensors and/or the processor 100 of the controller 20 may be provided to the controller of an associated game device as user input thereto.

While in one embodiment the mechanism for resisting and preventing movement of the user input device 22 may be same, in other embodiments they might be different. For example, in one embodiment, the mechanism described above may be used to resist movement of the user input device 22 relative to one or more of the axes. However, a different locking mechanism might be used to entirely lock or prevent rotation of the user input device 22 about one or more of the axes. For example, instead of such a locking mechanism comprising an opposing force generating mechanism as described above, a resistive breaking mechanism might be used (such as locking pins, friction pads or other elements coming into engagement with a shaft or portion thereof). In some embodiments, for example, a gear might be located on a shaft and a solenoid-activated pin might be moved into and out of engagement with the gear to selectively prevent the associated shaft from rotating.

The invention has a number of significant advantages. One advantage is a multi-mode controller which can be used with a gaming device to permit different modes of input, such as for different games or games having different input requirements. For example, as noted above, the controller may be used as a “driving mode” input device for a first driving game at a gaming device and a second “turret mode” input device, such as for a second tank game at the gaming device, or may provide those different modes of operation at different times during the same game at the gaming device.

Another advantage of the invention is a movement control mechanism which can be used to prevent certain movements of the input device and resist certain movements of the input device. Some prior art input devices require complex physical locking mechanisms to prevent movement of an input device, such as sliding locking pins. One advantage of the invention is a single mechanism that can both lock or limit movement, thus providing a “locking” haptic to the user, but also resist movement of the input device, thus providing an operational haptic feedback to the user which simulates a real world input.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. An input controller for a player of a video-based event, comprising:
a user engaging portion;
a base portion;
a mounting portion;
the user engaging portion mounted to the mounting portion for selective rotation about a first axis, the mounting portion mounted to the base portion for selective rotation about a second axis, thus permitting said user engaging portion mounted to said mounting portion to rotate about said second axis, and the base portion mounted for selective rotation about a third axis, thus permitting said user engaging portion to rotate about said third axis;
means for restricting movement of said user engaging portion about said first axis, said base portion about said second axis and said mounting portion about said third axis;
a processor;
a memory embodying non-transitory machine-readable code, said machine-readable code when executed by the processor configured to cause the processor to:
implement a first operational controller mode which causes said means for restricting to prevent movement of said user engaging portion about said first axis but permits said user engaging portion to rotate about said second axis and said third axis; and
implement a second operational controller mode which causes said means for restricting to prevent movement of said user engaging portion about said second axis and said third axis and permits said user engaging portion to rotate about said first axis.

2. The input controller in accordance with claim 1, wherein said user engaging portion if a yoke or wheel.

3. The input controller in accordance with claim 1, wherein said user engaging portion is mounted to the mounting portion via a first rotatable shaft, said mounting portion is mounted to said base portion by a second rotatable shaft, and said base portion is mounted for rotation about said third axis via a third shaft.

4. The input controller in accordance with claim 3, wherein said means for restricting movement comprise a first motor having an output which engages said first shaft, a second motor having an output which engages said second shaft, and a third motor having an output which engages said third shaft.

5. The input controller in accordance with claim 1, wherein said means for restricting movement resists movement of said user engaging portion about said second axis and said third axis in said first operational controller mode.

6. The input controller in accordance with claim 1, wherein said means for restricting movement resists movement of said user engaging portion about said first axis in said second operational controller mode.

7. The input controller in accordance with claim 1, wherein said processor is configured to implement said first and second operational controller modes in response to an output signal of a game controller.

8. The input controller in accordance with claim 1, further comprising a first sensor configured to generate an output which is dependent upon a first user input to said user engaging portion for effectuating movement of said user engaging portion about said first axis, a second sensor configured to generate an output which is dependent upon a second user input to said user engaging portion for effectuating movement of said user engaging portion about said second axis, and a third sensor configured to generate an output of which is dependent upon a third user input to said user engaging portion for effectuating movement of said user engaging portion about said third axis.

10. The input controller in accordance with claim 8, wherein said outputs of said first, second and third sensors are provided to said processor.

11. A method of operating a player input controller having a user engaging portion for receiving input by a player to a video-based event, the user engaging portion selectively movable about orthogonal first, second and third axes, comprising:
receiving, at a processor of said player input controller, a first instruction to implement a first input mode;
generating, by said processor, an output which causes a movement restrictor to prevent movement of said user engaging portion about said first axis but permit said user engaging portion to rotate about said second axis and said third axis;
receiving, at said processor of said player input controller, a second instruction to implement a first input mode; and
generating, by said processor, an output which causes a movement restrictor to prevent movement of said user engaging portion about said second axis and said third axis but permit said user engaging potion to rotate about said first axis.

12. The method in accordance with claim 11, wherein said user engaging portion is rotatably mounted to a base portion about said first axis, said base portion is rotatably mounted to a mounting portion about a second axis, and said mounting portion is mounted for movement about said third axis.

13. The method in accordance with claim 12, wherein said user engaging portion is mounted to a first shaft which is rotatable about said first axis, said base portion is mounted to a second shaft which is rotatable about said second axis, and said mounting portion is mounted to a third shaft which is rotatable about said third axis.

14. The method in accordance with claim 13 wherein said movement restrictor comprises a motor which has an output in communication with at least one of said first shaft, said second shaft and said third shaft.

15. The method in accordance with claim 14, wherein said motor drives a belt.

16. The method in accordance with claim 12, wherein said user engaging portion comprises a yoke.

17. The method in accordance with claim 11, further comprising generating an output which causes said movement restrictor to resist movement of said user engaging portion about said second axis and said third axis in said first input mode, and generating an output which causes said movement restrictor to resistant movement of said user engaging portion about said first axis in said second input mode.

18. An input controller for a player of a video-based event, comprising:
a user engaging portion movably mounted relative to a mount via a first shaft which rotates about a first axis, a second shaft which rotates about a second axis which is orthogonal to said first axis and a third shaft which rotates about a third axis which is orthogonal to said first axis and said second axis,
a first movement restrictor configured to restrict movement of said user engaging portion about said first axis;
a second movement restrictor configured to restrict movement of said user engaging portion about said second axis;
a third movement restrictor configured to restrict movement of said user engaging portion about said third axis;
a processor;
a memory embodying non-transitory machine-readable code, said machine-readable code when executed by the processor configured to cause the processor to:
implement a first operational controller mode which causes said first movement restrictor to prevent movement of said user engaging portion about said first axis and causes said second and third movement restrictors to resist movement of said user engaging portion about said second axis and said third axis; and
implement a second operational controller mode which causes said second and third movement restrictors to prevent movement of said user engaging portion about said second axis and said third axis and causes said first movement restrictor to resist movement of said user engaging portion about said first axis.

19. The input controller in accordance with claim 18, wherein said user engaging portion comprises a yoke or wheel.

20. The input controller in accordance with claim 19, wherein said yoke or wheel is mounted to said first shaft.
